(19) United States
(12) Patent Application Publication
(10) Pub. No.: US 2018/0048655 A1
(43) Pub. Date: Feb. 15, 2018

(54) Access Network Determination

(71) Applicant: Telefonaktiebolaget LM Ericsson (publ), Stockholm (SE)

(72) Inventors: Jerker Zetterlund, Bromma (SE); Afshin Abtin, Sollentuna (SE); Magnus Hallenstål, Täby (SE); Håkan Österlund, Ekerö (SE)

(21) Appl. No.: 15/556,492

(22) PCT Filed: Mar. 10, 2015
(86) PCT No.: PCT/EP2015/054977

§ 371 Date: Sep. 7, 2017

(51) Int. Cl. H04L 29/06; H04W 8/10; H04W 12/08; H04W 64/00; H04W 8/04; H04W 12/06; H04W 8/20; H04W 48/04

(52) U.S. Cl. CPC H04L 63/107; H04W 8/20; H04W 8/10; H04L 65/1016; H04W 48/04; H04L 65/1073; H04W 64/00; H04W 8/04; H04L 63/0892; H04W 12/06; H04W 12/08; H04W 88/16

(57) ABSTRACT

The invention relates to a method, by a subscriber database entity (200), to handle a request for subscriber information for a data packet session of one of the subscribers. The subscriber database entity comprises a storage unit (230) storing information about subscribers to a mobile communications network. The method comprises the following steps: receiving a first request for subscriber information for said one subscriber from an application server entity which provides a service to the data packet session, the first subscriber request including service information about the service provided to the data packet session; transmitting, in response to the received first request a second request for information about said one subscriber to at least one of a subscriber authentication entity (110). The subscriber authentication entity (110) is configured to authenticate the subscriber and to provide location information of the subscriber and a mobility entity (90). The mobility entity (90) is configured to manage a mobility of the subscriber. The second request includes the service information.

### TECHNICAL FIELD

The present invention relates to a method to handle a request for subscriber information by a subscriber database entity and to the corresponding subscriber database entity. The invention furthermore relates to a method for operating a session control entity and to the corresponding session control entity. Additionally, the invention relates to a gateway configured to provide access to a packet data network and to a method for operating the gateway. Furthermore, the invention relates to a subscriber authentication entity, a method for operating the latter and to a method for operating a mobility entity configured to manage a mobility of subscribers in a mobile communications network and to the corresponding mobility entity.

### BACKGROUND

Operators in mobile communications networks have started to offer IMS (IP Multimedia Subsystem) based on voice and video calling over LTE (Long Term Evolution) services. Furthermore, technologies have been developed to carry voice and/or video calls over WiFi. Thus, a mobile entity can use WiFi or the radio access in a network of the mobile communications network for accessing the mobile telecommunications network.

When both, the WiFi access or Evolved Packet Core Integrated WiFi Access and the cellular network access (e.g. via LTE or 3G) are deployed simultaneously for IMS services, it is important for charging and data retention purposes to correctly record the access type used for the service. The used access type is typically recorded via charging records generated by the application server (AS) applying the service to the data packet session. The application server retrieves the used access type from the subscriber database of the network such as the HSS (Home Subscriber Server).

A mobile entity/UE may simultaneously be using more than one APN (Access Point Name) for different services (for example video/voice over IMS APN and RCS (Rich Communication Suite) messaging over Internet APN). The APNs or services may be used on cellular access or EPC Integrated WiFi. In those cases, the AS needs to relay the Sh pull request with the correct service or APN. However, the AS cannot always know which APN is used for a specific service. As a result, a charging output may specify an incorrect access type, by way of example indicating LTE access when a message was actually delivered over WiFi.

Accordingly a need exists to avoid the above mentioned drawbacks and to make sure that the correct access type of a mobile entity can be determined.

### SUMMARY

This need is met by the features of the independent claims. Further aspects are described in the dependent claims.

The invention relates to a method to handle a request for subscriber information for a data packet session of one of the subscribers by a subscriber database entity wherein the subscriber database entity comprises a storage unit storing information about subscribers to a mobile communications network. The subscriber database entity receives a first request for subscriber information for said one subscriber from an application server entity which provides a service to the data packet session. This first subscriber request includes service information about the service provided to the data packet session. In response to the received first request a second request for information about said one subscriber is transmitted to at least one of a subscriber authentication entity configured to authenticate the subscriber and configured to provide location information of the subscriber and a mobility entity configured to manage a mobility of the subscriber, the second request including the service information.

The service information can include information about an access location of said one subscriber to the data packet network for the data packet session or a service identifier identifying the service applied to the data packet session.

By including the service information such as the access location or access point name into the received request and by including the service information in the request forwarded to the subscriber authentication entity and/or mobility entity, the entities to which the second request is transmitted can use the service information such as the access location/access point to identify whether the corresponding entity is handling the data packet session for which the request is received. If the subscriber is using the WiFi access, the authentication entity is aware of the data packet session and can respond to the second request. If a cellular access is used, the mobility entity is aware of the data packet session and can provide a response message to the subscriber database entity.

According to another aspect, the corresponding subscriber database entity is provided which can operate as described above, the subscriber database entity comprising a storage unit configured to store information about subscribers to the mobile communications network. A receiver is configured to receive the first request, the first request including the service information as mentioned above. Furthermore, a transmitter is provided which transmits in response to the received first request a second request to at least one of the subscriber authentication entity and the mobility entity.

According to another aspect, a method for operating a session control entity is provided which is configured to control a data packet session of the subscriber in the mobile communications network. The session control entity receives a first registration request in which it is requested to register the data packet session of the subscriber, this first request including service information about the service provided to the data packet session in response to the received first registration request, a second registration request is transmitted to a further session control entity of the mobile communications network, wherein the second registration request includes the service information about the service provided to the data packet session.

The invention furthermore relates to the corresponding session control entity configured to control the data packet session of the subscriber comprising a receiver configured to receive the first registration request as mentioned above and a transmitter configured to transmit in response to the received first registration request the second registration request to a further session control entity of the mobile communications network, both requests including the service information as discussed above.

The session control entity can be a Proxy Call Session Control Function, P-CSCF, of the mobile communications network, wherein the first registration request may be received from a policy control entity configured to control the policy rules of the mobile communications network or directly from the mobile entity requesting the data packet session. The second registration request may be transmitted from the P-CSCF to the Interrogating Call Session Control Function, I-CSCF, when the subscriber requesting the data packet session is connecting to the mobile communications network.

The different requests mentioned above can be requests according to a session initiation protocol, SIP.

The invention furthermore relates to a gateway configured to provide access to a packet data network for a data packet session of a subscriber of a mobile communications network. The gateway comprises a receiver configured to receive a request for establishing the data packet session for the subscriber the request containing information which radio access technology is used by the subscriber for the data packet session. A processing unit is provided configured to identify which radio access technology is used based on the received request. Furthermore, a first interface connected to a first session control entity configured to control the data packet session is provided and a second interface connected to another second session control entity configured to control the data packet session is provided. The processing unit is configured to forward the received request either to the first or the second interface in dependence on the identified radio access technology.

In this embodiment different interfaces are used for different radio access technologies and it allows the gateway to direct the traffic in dependence on the used radio access technology to a special session control entity.

The invention furthermore relates to the corresponding method to operate the gateway in which the request for establishing the data packet session for the subscriber is received including the information which radio access technology is used for the data packet session. Based on the request it is identified which radio access technology is used and the received request is either forwarded to a first interface connected to a first session control entity or to a second interface connected to a second session control entity in dependence on the identified radio access technology.

The invention furthermore relates to a method for operating a subscriber authentication entity in a mobile communications network through which a data packet session is passed for one of the subscribers of the mobile communications network. A request is received from a subscriber database entity about said one subscriber, the request containing service information about the service provided to the data packet session. It is determined whether a data packet session is handled by the subscriber authentication entity which has the same service information as the service information contained in the request. In the affirmative, a response message is transmitted to the subscriber database entity, the response message including the information about the radio access technology. The invention furthermore relates to the corresponding subscriber authentication entity including a receiver configured to receive the request from the subscriber database entity as mentioned above. The subscriber authentication entity furthermore comprises at least one processing unit which operates as discussed above in connection with the subscriber authentication entity.

Furthermore, a method for operating a mobility entity is provided which is configured to manage a mobility of subscribers in a mobile communications network through which a data packet session for one of the subscribers of the mobile communications network. A request is received from a subscriber database about said one subscriber, the request containing the service information about the service provided to the data packet session. Furthermore, it is determined whether the data packet session is handled by the mobility entity which has the same service information as the service information contained in the request. In the affirmative, a response message is transmitted to the subscriber database entity which includes the information about the radio access technology used by said one subscriber for the data packet session.

The invention furthermore relates to the corresponding mobility entity including a receiver configured to receive the request and including at least one processing unit to determine whether a data packet session is handled by the mobility entity as mentioned above in connection with the method.

When a request is received by the mobility entity or the subscriber authentication entity from the subscriber database entity, the corresponding entity, the mobility entity or the subscriber authentication entity can respond with the requested information as one of the two entities handles the data packet sessions, for which the request is received.

The invention will be described in further detail with reference to the accompanying drawings.

### BRIEF DESCRIPTION OF THE DRAWINGS

FIG. 1 is a schematic view of a message flow indicating how an information about an access location or a service is transmitted over a mobile communications network.

FIG. 2 shows another embodiment of a message flow used to transmit service information such a service identifier or an access location of a subscriber through the network.

FIG. 3 is a schematic representation of a subscriber database entity used in the message exchange shown in FIGS. 1 and 2.

FIG. 4 is a schematic representation of a session control entity involved in the message flow shown in FIGS. 1 and 2.

FIG. 5 shows a further embodiment of a message flow to convey the service information through the network.

FIG. 6 is a schematic representation of a gateway used in the flow exchange of FIG. 5.

FIG. 7 is a schematic view of a subscriber authentication entity used in a message flow as shown in FIGS. 1, 2 and 5.

FIG. 8 is a schematic view of a mobility entity used in a message flow as indicated in FIG. 1, 2 or 5.

### DETAILED DESCRIPTION OF EMBODIMENTS

In the following, embodiments of the invention will be described in detail with reference to the accompanying drawings. It is to be understood that the following description of embodiments is not to be taken in a limiting sense. The figures are to be regarded as being schematic representations and elements illustrated in the drawings are not necessarily shown to scale. Rather, the various elements are represented such that their function and general purpose becomes apparent for a person skilled in the art. Any connection or coupling between functional blocks, devices, components or other physical or functional units shown in the drawings or described herein may also be implemented by indirect connection or coupling. A coupling between components may be established over a wireless connection, or a wired connection. Functional blocks may be implemented in hardware, firmware, software, or a combination thereof.

Furthermore, features mentioned above and features yet to be explained below may not only be used in isolation or in the combination as explicitly indicated, but also in other combinations. Features and embodiments of the present application may be combined unless explicitly mentioned otherwise.

As will be described in more detail below, a PDN gateway is the entity which knows which access location or access point name, APN, is used for a specific IMS contact of a subscriber. One aspect described in the invention is that a session control entity such as a P-CSCF (Proxy Call Session Control Function) populates the SIP registration signaling with a new contact parameter indicating the used access technology or indicating the service using a service identifier. An application service entity (AS) receives third party registrations which keeps the AS up to date on the currently used access technology.

Furthermore, a subscriber database such as the HSS can use the access technology/APN or service identifier when requesting information from a mobility entity such as the MME (Mobility Management Entity) and/or a subscriber authentication entity such as an authentication, authorization and accounting entity, AAA, if the packet data network, PDN connection for the specific APN is set up over LTE or WiFi. The P-CSCF informs which APN or service is used and the AS requests the used access technology from a subscriber database using the received information.

The invention is described in an IMS context. However, it should be understood that any system that makes use of CS/LTE/WiFi radio coverage and provides services over multiple PDNs to subscribers could implement the invention to determine which access technology is used. When the used access should be found out, the request should specify the relevant access location or service and the AS requests the used access from a subscriber database.

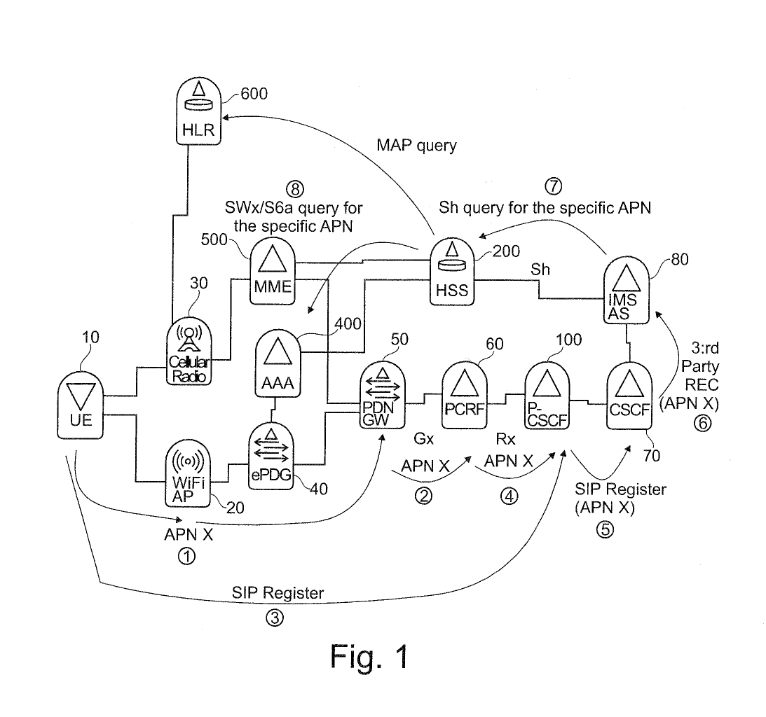

FIG. 1 shows a message flow including several elements of a mobile communications network. In the example shown in FIG. 1 APN X is an example APN which could be an IMS APN or could be another APN for other services, e.g. Internet APN used for IMS messaging. A mobile entity 10 requests the establishment of an IP CAN (IP Connectivity Access Network) session for APN X. Depending on which radio access technologies are available if the UE 10 is in a cellular and/or WiFi coverage range and the preferences of the UE and the network, the IP CAN session may be established over a cellular or WiFi access. If it is established over a WiFi access, the session is established via WiFi access point 20 and the Evolved Packet Data Gateway 40, ePDG, before reaching the PDN gateway 50. As shown in FIG. 1, the ePDG 40 is connected to the Authentication Authorization and Accounting entity 400, AAA. If the IP CAN session is established over the cellular network, it is established over the cellular radio part 30, the MME 500 and the PDN gateway 50. In the second step shown in FIG. 1, the PDN gateway 50 initiates a related IP session to be created in the PCRF (Policy and Charging Rules Function) 60 and indicates which APN or service the IP session is set up for.

In step 3 the UE 10 registers with the Proxy Call Session Control Function 100, P-CSCF, on the particular PDN created in the previous steps.

In step 4, before processing the registration to the IMS core network, the P-CSCF 100 creates an AF session (Application Function session) for the registration with the PCRF 60. The PCRF 60 ties the IP session created at step 2 with this AF session and can thus provide the used APN to the P-CSCF 100.

In step 5, when forwarding the registration to the CSCF (Core Session Control Function) 70, the P-CSCF 100 includes a new parameter indicating “PDN connection=APN X”. By way of example, the new parameter can be included as a new contact parameter or extension to PANI (P Access Network Info). In step 6, the CSCF 70 generates a third party registration message to inform an application server, AS, such as IMS application server 80 which APN the UE is connected to. This registration message contains the information about the access technology such as “PDN connection=APN X”.

In step 7, at the time when the AS 80 needs to retrieve the access technology of the UE 10, for example when terminating an RCS (Rich Communication Suite) message to the UE 10, the AS 80 initiates an Sh pull including a parameter about the used access technology, e.g. “requested APN=APN X”. As an alternative to the requested APN, the AS 80 could set “requested service=service X”. The reason for indicating a service instead of an APN is that the service more generic and would also cover cases when the UE 10 is not available on packet switched access, but is on circuit switched access where the APN is not used. The AS 80 would in this case need to hold a table of the mapping between the APN and the service. Thus, in this embodiment a service identifier is contained in the request sent in step 7 to the subscriber database entity or HSS 200. Some services may not use a PDN connection tied to an APN so that it is also possible to use a service identifier instead of an APN to be transmitted instead of the APN in the steps mentioned above.

In step 8, the HSS 200 thereafter retrieves the access technology from AAA 400 and/or the MME 500. The HSS sends a specific request to one or both of these two entities including the service information such as the service identifier or the information about the access technology or access location. If the APN or service is provided by a circuit switched access, then the HSS may also perform a MAP (Mobile Application Part) query to the HLR to request the used access technology from circuit switched.

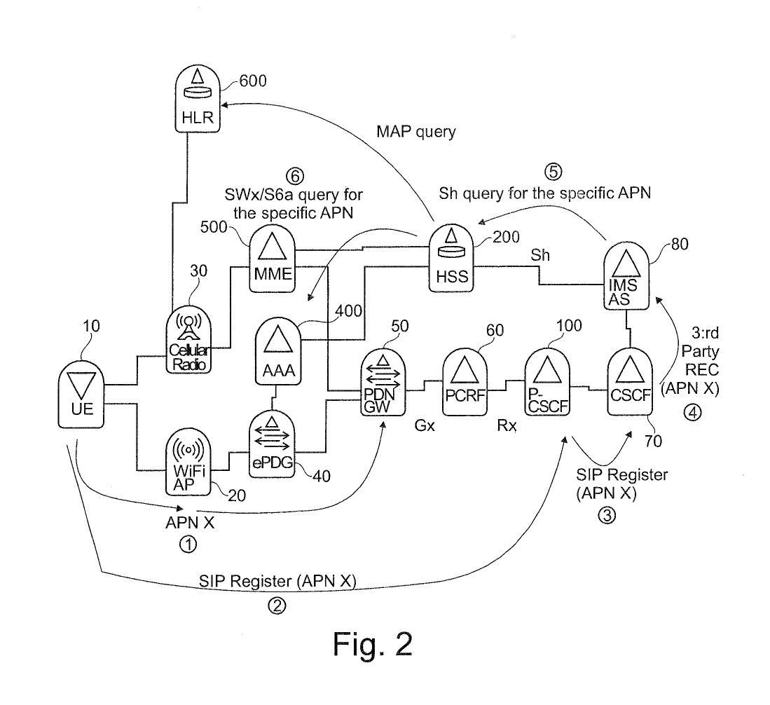

FIG. 2 shows a slightly different embodiment which, compared to the embodiment of FIG. 1, shows that the UE 10 directly indicates the used APN in the registration signaling. Thus, step 1 shown in FIG. 2 corresponds to step 1 explained above in connection with FIG. 1. Step 2 corresponds to former step 2, however the access technology or service information is contained in the SIP registration message used to initiate the IP session. Steps 3, 4, 5 and 6 of FIG. 2 correspond to steps 5, 6, 7 and 8 discussed above in connection with FIG. 1.

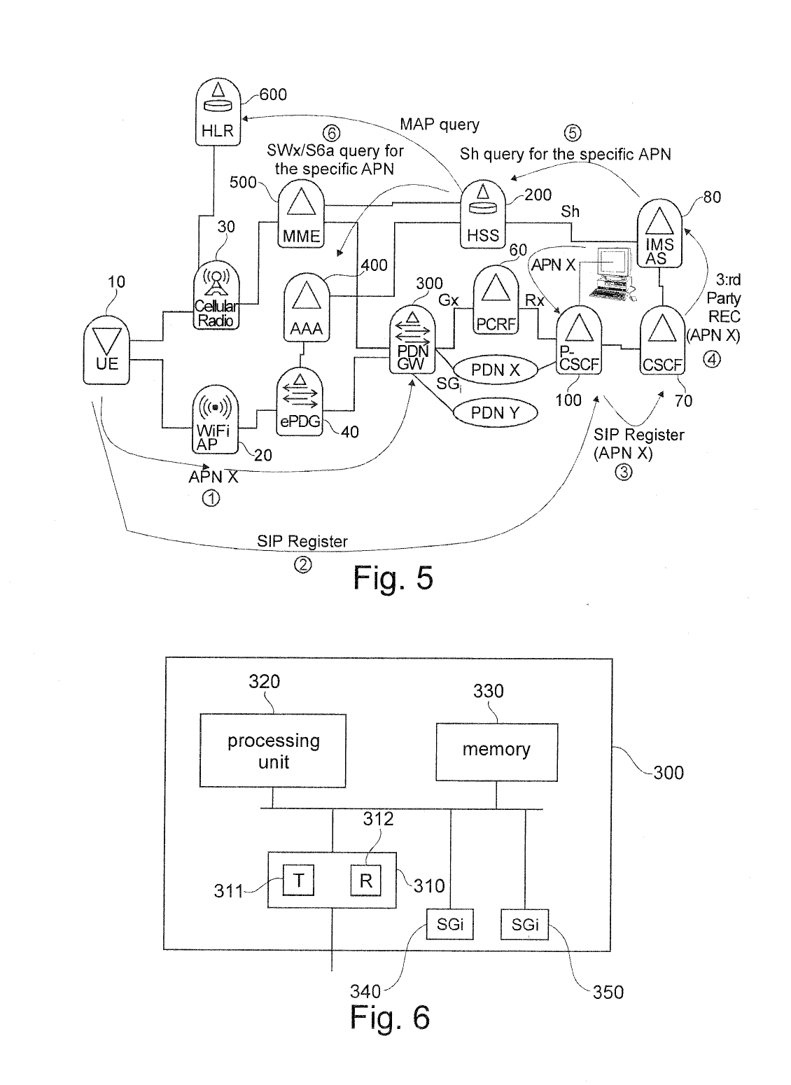

FIG. 5 shows another embodiment which differs from the embodiments discussed above in connection with FIGS. 1 and 2 by the fact that the PDN gateway 300 is configured to use different SGi interfaces to different APNs. This allows the PDN gateway 300 to direct the traffic from a particular PDN connection to a specific logical P-CSCF 100. Each logical P-CSCF 100 could then be configured with a specific APN, as it would know that all traffic coming in from the PDN gateway 300 is related to the specific access technology or APN. Thus, steps 1 and 2 shown in FIG. 5 correspond to steps 1 and 2 discussed above in connection with FIG. 1. Steps 3 to 6 correspond to steps 5 to 8 of FIG. 1. The set-up of FIG. 5 can reduce or simplify the signaling on the Gx/Rx interface, but on the other hand requires additional configuration to be correlated between the PDN gateway 300 and the P-CSCF 100. In the embodiment of FIG. 5, the other P-CSCF connected to the second SGi interface is not shown for clarity reasons. Thus, a session request for APN X is transmitted via a first interface to a first P-CSCF, wherein a session request including another session identifier or information about the access technology is transmitted to another P-CSCF.

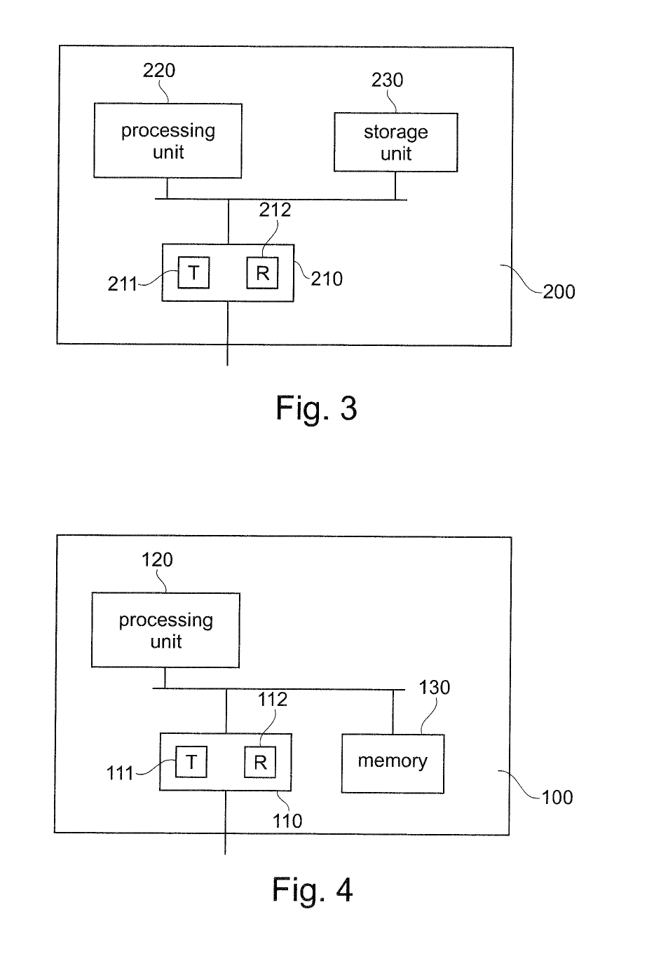

FIG. 3 shows a schematic view of the HSS (200) used in the embodiments discussed above in connection with FIGS. 1, 2 and 5. The HSS comprises an input/output unit 210 including a transmitter 211 and a receiver 212. The input/output unit 210 represents the possibility of the HSS 200 to communicate with other nodes such as the nodes shown in FIG. 1 of the mobile communications network or other nodes outside the mobile communications network. The transmitter 211 provides the possibility to transmit control messages or user data to other nodes, the receiver 212 providing the possibility to receive control messages or user data from other nodes. By way of example, the receiver receives the request from the AS 80 for the specific APN and the transmitter transmits the request to MME 500 and AAA 400. The HSS furthermore comprises a processing 220 which comprises one or more processors and which is responsible for operating the HSS 200. The processing unit 220 can generate the commands that are needed to carry out procedures of the HSS discussed above or discussed below in which the HSS (200) is involved. A storage unit 230 is provided to inter alia store the information about the subscribers of the mobile communications network. The storage unit can furthermore store a suitable program code to be executed by the processing unit 220 so as to implement the needed functionalities of the ASS 200.

FIG. 4 shows a schematic view of a session control entity such as the P-CSCF 100 shown in FIGS. 1, 2 and 5. The P-CSCF 100 also comprises an input/output unit 110 with a transmitter 111 and a receiver 112. As discussed above in connection with the HSS 200, the input/output unit represents the possibility to transmit data to other entities or nodes and to receive control messages or user data from other nodes. The processing unit 120 comprising one or more processors is responsible for the operation of the P-CSCF 100 and can generate the commands that are used to carry out the procedures of the P-CSCF 100 discussed above or below in which the P-CSCF 100 is involved. A memory 130 such as a read-only memory, flash memory, random access memory, mass storage or the like can store a suitable program code to be executed by the processing unit 120 so as to implement the needed functionalities of the P-CSCF.

FIG. 6 shows a schematic implementation of a gateway which is used in the embodiment of FIG. 5 explained above. The gateway also comprises an input/output unit 310 with a transmitter 311 and a receiver 312 for exchanging control messages or user data with other nodes. Furthermore, the processing unit 320 comprising one or more processors is provided and is responsible for the operation of the gateway 300. In addition to the general input/output unit 310, the two different interfaces 340 and 350 are shown. The two interfaces 340 and 350, here SGi interfaces, symbolize the possibility of the gateway to use one interface such as interface 340 which is connected to a first P-CSCF, wherein the other interface 350 is connected another P-CSCF. Thus, the gateway can direct the traffic from a particular PDN connection to a specific P-CSCF using one of the interfaces 340 or 350.

A memory 330, such as the read-only memory, flash memory, random access memory or mass storage or the like, is provided to store a suitable program code to be executed by the processing unit 320 so as to implement the needed functionalities of the gateway described above or below.

Each SGi interface or logical P-CSCF should be able to handle both WiFi and LTE access as a mobile entity will move between both accesses and will be connected to the same SGi or P-CSCF.

In the embodiments described above in connection with FIGS. 1, 2 and 5, the application server 80 accesses the HSS for the location of the user. As furthermore discussed above, the HSS forwards this request to AAA 400 and MME 500 to determine the location and the used access technology. The access technology cannot be directly retrieved from the APN as the APN is the IP tunnel from the UE to the PDN gateway set up for the data packet session. However, based on the access technology or APN or service identifier contained in the information transmitted by the HSS, either the AAA 400 or the MME 500 can provide the needed information depending on which access technology is used.

The service applied by the application server may be a telephony service such as the generation of a busy tone or the transmission of the call to a voice mail. Another example of the service applied by the application server can be call forwarding, call waiting, etc. With the transmitted service information such as the service identifier identifying the service or the access technology, the tunnel can be uniquely identified. The MME 500 or the AAA 400 check whether they have the requested APN active and can then respond with the requested information. By way of example, a UE 10 may have an IMS APN active over WiFi access and, at the same time, have the Internet APN active over LTE access so that multiple APNs are present on different access technologies. The node having the requested APN active, the MME 500 or AAA 400, can then give a positive answer so that it is possible to correctly charge for the used service. The other node not having the corresponding APN active may still send a response; however this would then be a negative response. If the requested APN is active on WiFi access, then the AAA 400 handles the information about the UE 10 and the AAA 400 would respond with the requested information. If the requested APN is active on LTE access, then the MME 500 handles the information about the UE 10 and the MME would respond with the requested information. If the requested service is provided by circuit switched, then the HLR (not shown) would respond with the requested information.

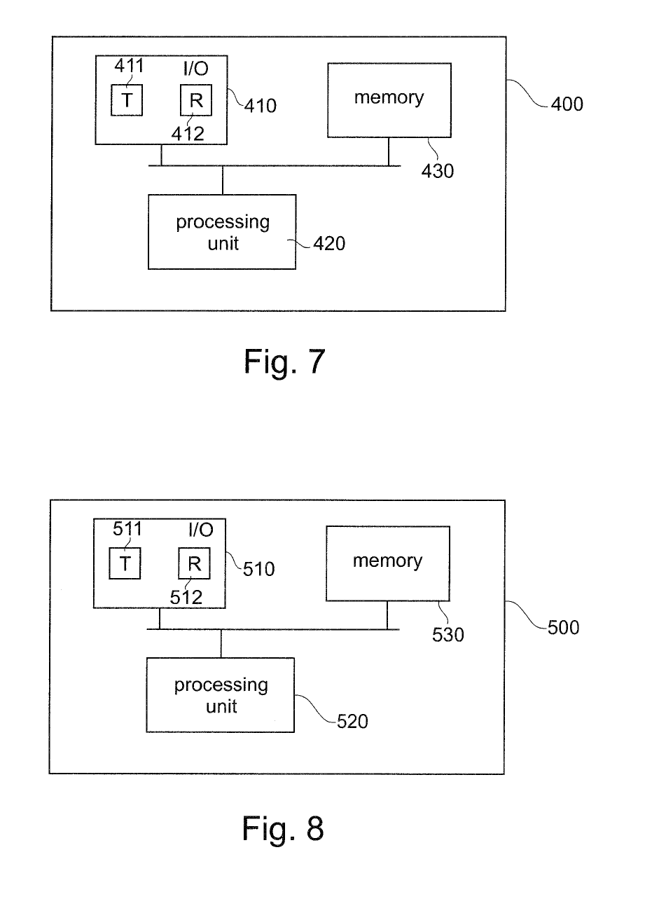

FIGS. 7 and 8 show the AAA 400 and the MME 500 respectively. In this schematic view of FIG. 7, the AAA 400 comprises an input/output unit 410 with a transmitter 411 and a receiver 412. The input/output unit 410, as the other input/output units shown in FIGS. 3, 4 and 6, is responsible for the exchange of user data and control messages with other nodes, whereas processing unit 420 is responsible for the operation of the AAA as discussed above. Memory 430 can store a suitable program code to be executed by the processing unit 420 to implement the above discussed functionalities in which the AAA is involved. In the same way, MME 500 comprises an input/output unit 510 with a transmitter 511 and a receiver 512. A processing unit 520 is responsible for the operation of the MME 500, and memory 530 can store a program code to be executed by processing unit 520 to implement the needed functionalities of the MME 500.

From the above discussions of the different embodiments, some general conclusions can be drawn.

The service information contained in the request received by the subscriber database entity can contain information about an access location of the subscriber to the data packet network for the data packet session. Furthermore, the service information can contain a service identifier which identifies the service applied to the data packet session.

The request received by the subscriber database entity HSS 200 can be received from an application server entity of an IP Multimedia Subsystem, IMS.

Furthermore, the subscriber database entity, such as the HSS 200, can receive a response message in response to the second request, i.e. the request which is transmitted in response to the first request is received from the AAA or the MME. The response message then includes the information about the radio access technology used by the subscriber for the data packet session. Furthermore, the subscriber database entity can forward the response to the application server 80 which requested the information.

As can be seen from the figures above, the first request received by the subscriber database entity 200 can be an Sh pull request.

Furthermore, it is possible that the first registration request received the P-CSCF session control entity 100 and the second request transmitted to CSCF 70 can be requests according to the session initiation protocol. Furthermore, the received and transmitted service information can contain the APN packet data network connection of the subscriber.

Additionally, as can be deduced from FIGS. 1, 2 and 5, the first registration request can be received from a policy control entity such as PCRF 60 which is configured to control the policy rules in the mobile communications network. However, as discussed in connection with FIG. 2, this registration request may be also be received directly from the mobile entity 10.

Summarizing, according to one aspect, the Sh pull request for the access type information specifies the requested APN or service to the HSS 200. Furthermore, the requested APN is specified to the MME and AAA over S6A/SWX to ensure the access type information is correct for the relevant APN.

Furthermore, the APN information is provided to the AS to enable the AS to request information such as the used access technology for the service. Furthermore, a mechanism is provided to provide the APN information by the P-CSCF indicating APN and SIP signaling.

One advantage of the above discussed solution is that it enables the IMS and charging entities to accurately capture the access type used to carry the IMS service. This furthermore allows an operator to collect statistics on how the access network is used and to give adequate customer support when receiving subscriber questions. Furthermore, it is possible to differentiate charging between different access technologies and it is possible to fulfill regulatory requirements on data retention.

1-25. (canceled)

26. A method, by a subscriber database entity, to handle a request for subscriber information for a data packet session of one of the subscribers, the subscriber database entity comprising a storage unit storing information about subscribers to a mobile communications network, the method comprising:
receiving a first request for subscriber information for the one subscriber from an application server entity which provides a service to the data packet session, the first subscriber request including service information about the service provided to the data packet session;
transmitting, in response to the received first request, a second request for information about the one subscriber to at least one of a) a subscriber authentication entity configured to authenticate the subscriber and configured to provide location information of the subscriber and b) a mobility entity configured to manage a mobility of the subscriber;
wherein the second request includes the service information.

27. The method of claim 26, wherein the service information contains information about an access location of the one subscriber to a data packet network for the data packet session.

28. The method of claim 26, wherein the service information contains a service identifier identifying the service applied to the data packet session.

29. The method of claim 26, wherein the first request is received from an application server entity of an IP Multimedia Subsystem.

30. The method of claim 27, further comprising:
receiving a response message, in response to the second request, from one of the subscriber authentication entity and the mobility entity, the response message containing the service information corresponding to the service information contained in the second request, the response message including information about a radio access technology used by the one subscriber for the data packet session;
forwarding the response message to the application server entity.

31. The method of claim 26, wherein the received first request is a Sh pull request.

32. A subscriber database entity configured to handle a request for subscriber information, the subscriber database entity comprising:
a storage unit configured to store information about subscribers to a mobile communications network;
a receiver configured to receive a first request for subscriber information about one of the subscribers from an application server entity which provides a service to the data packet session, the first request including service information about the service provided to the data packet session;
a transmitter configured to transmit, in response to the received first request, a second request for information about the one subscriber to at least one of a) a subscriber authentication entity configured to authenticate the subscriber and configured to provide location information of the subscriber and b) a mobility entity configured to manage a mobility of the subscriber;
wherein the second request includes the service information.

33. The subscriber database entity of claim 32, wherein the subscriber database entity is configured as a Home Subscriber Server of the mobile communications network.

34. A session control entity configured to control a data packet session of a subscriber in a mobile communications network, the session control entity comprising:
a receiver configured to receive a first registration request in which it is requested to register the data packet session of the subscriber, the first registration request including service information about the service provided to the data packet session;
a transmitter, configured to transmit, in response to the received first registration request, a second registration request to a further session control entity of the mobile communications network, the second request including the service information.

35. The session control entity of claim 34, wherein the session control entity is configured to operate as a Proxy Call Session Control Function of the mobile communications network.

36. A method for operating a session control entity configured to control a data packet session of a subscriber in a mobile communications network, the method comprising:
receiving a first registration request in which it is requested to register the data packet session of the subscriber, the first registration request including service information about the service provided to the data packet session;
transmitting, in response to the received first registration request, a second registration request to a further session control entity of the mobile communications network, the second registration request including the service information about the service provided to the data packet session.

37. The method of claim 36, wherein the first registration request and the second registration request is a registration request message according to a session initiation protocol.

38. The method of claim 36, wherein the service information contains an Access Point name of a packet data network connection of the subscriber.

39. The method of claim 36, wherein the first registration request is received from a policy control entity configured to control policy rules in the mobile communications network.

40. The method of claim 36, wherein the first registration request is received from a mobile entity requesting the data packet session.

41. A gateway configured to provide access to a packet data network for a data packet session of a subscriber of a mobile communications network, the gateway comprising:
a receiver configured to receive a request for establishing the data packet session for the subscriber, the request containing information which radio access technology is used by the subscriber for the data packet session;
a first interface connected to a first session control entity configured to control the data packet session;
a second interface connected to a second session control entity configured to control the data packet session;
processing circuitry configured to:
identify which radio access technology is used based on the received request;
forward the received request either to the first or second interface depending on the identified radio access technology.

42. The gateway of claim 41, wherein the first interface and the second interface are configured as Service Gateway Interfaces.

43. The gateway of claim 41, wherein the gateway is configured as a Packet data network gateway.

44. A method of operating a gateway which provides access to a packet data network for a data packet session of a subscriber of a mobile communications network, the method comprising:
receiving a request for establishing the data packet session for the subscriber, the request containing information which radio access technology is used by the subscriber for the data packet session;
identifying, based on the request, which radio access technology is used;
forwarding the received request either to a first interface connected to a first session control entity configured to control the data packet session or to a second interface connected to a second session control entity configured to control the data packet session, depending on the identified radio access technology.

45. A method for operating a subscriber authentication entity in a mobile communications network through which a data packet session is passed for one of the subscribers of the mobile communications network, the method comprising:
receiving a request from a subscriber database entity, about the one subscriber, the request containing service information about the service provided to the data packet session;
determining whether a data packet session is handled by the subscriber authentication entity which has the same service information as the service information contained in the request;
transmitting, in response to determining that a data packet session is handled by the subscriber authentication entity which has the same service information as the service information contained in the request, a response message to the subscriber database entity, the response message including information about a radio access technology used by the one subscriber for the data packet session.

46. The method of claim 45, wherein the service information contained in the received request contains information about an access location of the one subscriber to a data packet network for the data packet session.

47. A subscriber authentication entity of a mobile communications network through which a data packet session is passed for one of the subscribers of the mobile communications network, the subscriber authentication entity comprising:
a receiver configured to receive a request from a subscriber database entity about the one subscriber, the request containing service information about the service provided to the data packet session;
processing circuitry configured to:
determine whether a data packet session is handled by the subscriber authentication entity which has the same service information as the service information contained in the request;
initiate, in response to determining that a data packet session is handled by the subscriber authentication entity which has the same service information as the service information contained in the request, a transmission of a response message to the subscriber database entity, the response message including information about a radio access technology used by the one subscriber for the data packet session.

48. The subscriber authentication entity of claim 47, wherein the subscriber authentication entity is configured as an authentication, authorization, and accounting entity of the mobile communications network.

49. A method for operating a mobility entity configured to manage a mobility of subscribers in a mobile communications network through which a data packet session is passed for one of the subscribers of the mobile communications network, the method comprising:
receiving a request from a subscriber database entity about the one subscriber, the request containing service information about the service provided to the data packet session;
determining whether a data packet session is handled by the mobility entity which has the same service information as the service information contained in the request;
transmitting, in response to determining that a data packet session is handled by the mobility entity which has the same service information as the service information contained in the request, a response message to the subscriber database entity, the response message including information about a radio access technology used by the one subscriber for the data packet session.

50. A mobility entity configured to manage a mobility of subscribers in a mobile communications network through which a data packet session is passed for one of the subscribers of the mobile communications network, the mobility entity comprising:
a receiver configured to receive a request from a subscriber database entity about the one subscriber, the request containing service information about the service provided to the data packet session;
processing circuitry configured to:
determine whether a data packet session is handled by the mobility entity which has the same service information as the service information contained in the request, and configured to initiate;
transmit, in response to determining that a data packet session is handled by the mobility entity which has the same service information as the service information contained in the request, a response message to the subscriber database entity, the response message including information about a radio access technology used by the one subscriber for the data packet session.
